(19) United States
(12) Patent Application Publication
(10) Pub. No.: US 2010/0332245 A1
(43) Pub. Date: Dec. 30, 2010

(54) Integrated RFID sensor method and system

(75) Inventors: Suresh K. Choubey, Delafield, WI (US); Gopal B. Avinash, New Berlin, WI (US)

Correspondence Address: GE HEALTHCARE;c/o FLETCHER YODER, PC, P.O. BOX 692289, HOUSTON, TX, 77269-2289, US

(73) Assignee: General Electric Company

(21) Appl. No.: 11/606,672

(22) Filed: Nov. 30, 2006

(51) Int. Cl. G06Q 50/00; G06Q 10/00

(52) U.S. Cl. 705/2

(57) ABSTRACT

A healthcare system is provided with RF sensor modules that can be integrated into various components and subsystems or that can be retrofit. Sensors modules include a sensor adapted to detect operational data. The modules may process and store the data, and perform aggregation functions to simplify or reduce the data. The data is then collected from the modules by an RF transceiver and conveyed to downstream processing layers. The processing layers may evaluate the operation of the components or subsystems, or the overall health or functioning of the component, subsystem, or any other useful subdivision of the healthcare system.

### BACKGROUND

The present invention relates generally to healthcare systems, and more particularly to techniques for monitoring parameters indicative of the condition and utilization of various components of a healthcare system. Even more particularly, the invention relates to a radio frequency-based technique for interfacing sensors with data collection and analysis components in order to monitor and evaluate performance and utilization of portions of a medical or healthcare system.

A wide range of healthcare systems are currently in use for providing preventive and diagnostic care to patients. In general, such systems may include anything from patient visits for preventive and diagnostic procedures, checkups, and so-forth, to medical imaging procedures, to interventional, surgical, and other treatment. Many different components are, of course, used in providing healthcare. Those specifically found in hospitals and clinics include machines, monitors, imaging systems, and biomedical equipment, and so-forth. Other hospital and institutional systems include surgical equipment, pharmaceuticals, blood and plasma, to mention only a few.

In such complex and diverse systems, it has become extremely difficult to acquire useful data regarding the various components and systems in an installed base to predict or monitor the operational state of the various components and systems. Similarly, it is extremely difficult to acquire information for analysis of the usage of such components. While such data would be extremely useful for evaluating the operational state of healthcare components, such as to foresee their services needs, replacement needs, and so-forth, many obstacles currently stand in the way of acquiring such information. Such obstacles include the highly disparate nature of the systems, the inability to track operative systems in institutions and between suppliers and institutions, and the fact that many components are simply not designed to interface with data collection devices and systems. Upgrading equipment to provide for hard-wired exchange of parameter data, if possible at all, is simply cost-prohibitive. Many systems that could be monitored, such as for drug delivery, blood delivery, imaging system component usage, and so-forth, are simply ill-equipped or unsuitable for integrated monitoring devices, particularly data acquisition systems and subsystems.

There is a significant need in the healthcare field for improved techniques for monitoring and collection information from disparate components. Many attempts have been made at solving such challenges, including various approaches to “asset management.” However, previous approaches have generally relied upon a high degree of integration of the parameter detecting and reporting systems with the monitored assets or equipment. In certain approaches, very little or no real information regarding the informational status of the system or component would be known. For example, some asset management system provide only for tracking (i.e., identification and location information) for monitored assets. No sensing or reporting of operational data is typically provided.

### BRIEF DESCRIPTION

The present invention provides a technique for sensing, reporting and analyzing component operational data in a healthcare context designed to respond to such needs. The technique may be applied in a wide range of settings, but is particularly well-suited to equipment on which sensor and reporting modules can be retrofitted. Sensor modules may, where desired, be somewhat integrated with existing equipment, but may also provide for wholly separate sensing and reporting of operational parameter data. That is, the invention provides a technique in which the design and deployment of data acquisition subsystems in or on a device or component is independent of that of other subsystems of the device or component. The technique is based upon the use of sensor modules that have integrated radio frequency (RF) transceiver. The sensor modules are used to collect environment, usage, failure, and machine-specific data, and so-forth from the device or component. The integration of RF transceiver technology with sensor subsystems provides a cost-effective means for gathering location, characteristic, and sensor data together. Moreover, deployment may be accomplished at any time during or after the deployment of the device or component itself.

The sensor modules may also follow components through various phases of manufacturing, transport and use, enabling a reporting of important data that could heretofore go unknown, unreported or unanalyzed. The integrated RF sensor system thus provides for improved acquisition of all data needed to determine the health and usage of subsystems in a healthcare environment, while providing for independent deployment.

The invention may be used in a wide range of settings, and generally provides an architecture of integrated RF sensing and transceiving technologies that can be used for data acquisition on new and existing devices. The sensor/RF transceiver modules provide location information with regards to the associated device or component, as well as data regarding characteristics of the device or component. Such sensors can be used to acquire various types of machine data, such as environmental data (e.g., humidity and temperature), parametric data (e.g., frequencies, signal-to-noise ratios), vibration data, and so-forth. The sensors can be easily integrated with the RF transceivers to create an integrated sensing module. Moreover, RF-based location devices within the modules can acquire and transmit data, including location and utilization data. Such data may be used both to track and locate equipment and subsystems, and to obtain data, in real or near-real time regarding asset utilization. The modules can be placed on or in any way associated with the monitored components or subsystems, and content read via RF read/write technology.

In accordance with certain aspects of the present technique, then, a medical equipment system includes a medical data subsystem configured to access medical data. A data processing subsystem is configured to at least partially process the medical data for use in providing medical care. A controller subsystem is provided for regulating operation of the acquisition subsystem and the medical data processing subsystem. A plurality of sensors are associated with at least one of the medical data subsystem, the medical data processing subsystem and the controller subsystem for collecting serviceable medical equipment parameter data relating to a state of the associated subsystem. Each sensor is operatively associated with an RF transmitter. The system may further include an RF reader for retrieving sensor data, as well as location data from the associated subsystem by RF transmission from the respective transmitter.

In accordance with other aspects of the technique, a system for servicing medical equipment includes a subsystem and an RF reader. The subsystem, itself, includes an RF tag portion having a memory to store medical equipment information, a sensor portion, including a sensor to measure a serviceable medical equipment parameter data, a filter for aggregating at least part of the sensor data, and an transmitter for outputting at least part of the aggregated data. The RF reader retrieves the aggregated data and medical equipment information from the transmitter and extracts medical equipment information from the aggregated data for transmission to a service system that evaluates the serviceable medical equipment parameter data. Moreover, for equipment that may be displaced or moved within a facility, location information acquired or derived from data from the RF tag may be used to quickly locate the equipment. The combination of the RF tag and the sensor portion thus enables “just-in-time” type service of both institution (e.g., hospital) equipment as well as patients associated with such equipment.

The invention also provides a medical equipment service system that includes a medical equipment system, an RF reader and a service system. The medical equipment system, as before, includes a plurality of RF-linked subsystems. Each of the subsystems includes a sensor for collecting serviceable medical equipment parameter data from the subsystem and an RF transmitter for transmitting operational data from the subsystem. The RF reader retrieves serviceable medical equipment parameter data and device location data from the subsystems. The service system evaluates the serviceable medical equipment parameter data retrieved via the RF reader and determines operational servicing needs for the medical subsystem based upon the serviceable medical equipment parameter data. Moreover, as noted above, the location data may be used to locate the exact location of movable assets, such as ultrasound systems, IV systems, and other movable equipment and assets.

The invention also provides a system that includes a contributing entity that contributes the provision of medical care via an article. The article includes a RF tag portion that, itself, has a memory to store medical article information. A sensor portion of the entity includes a sensor to measure serviceable medical article parameter data. A filter is provided for aggregating at least a portion of the sensor data. A transmitter outputs at least a portion of the aggregated data and stored medical article information. An RF reader is provided for retrieving the aggregated data and medical article information from the transmitter. An analysis system identifies defects or service needs in the contributing entity based upon the aggregated data and the medical article information.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical overview of a healthcare system equipped with RF sensor modules for monitoring operation of subsystems or components in accordance with aspects of the present technique;

FIG. 2 is a diagrammatical representation of an exemplary imaging system used in a healthcare context and equipped with RF sensing modules in accordance with the present technique;

FIG. 3 is a diagrammatical representation of an exemplary magnetic resonance imaging system, as a particular implementation of the system of FIG. 2;

FIG. 4 is a diagrammatical representation of an exemplary computed tomography imaging system as a further exemplary implementation of the system of FIG. 2;

FIG. 5 is a diagrammatical representation of a component storage, transport and analysis system employing RF sensing modules in accordance with the present technique;

FIG. 6 is a diagrammatical representation of certain of the functional components that may be found in a typical RF sensing module in accordance with the present technique;

FIG. 7 is a diagrammatical representation of various data acquisition and processing layers that may be included in the overall healthcare system instrumented in accordance with the present technique; and

FIG. 8 is a diagrammatical representation of certain of the functional components implemented in the layers represented in FIG. 7.

### DETAILED DESCRIPTION

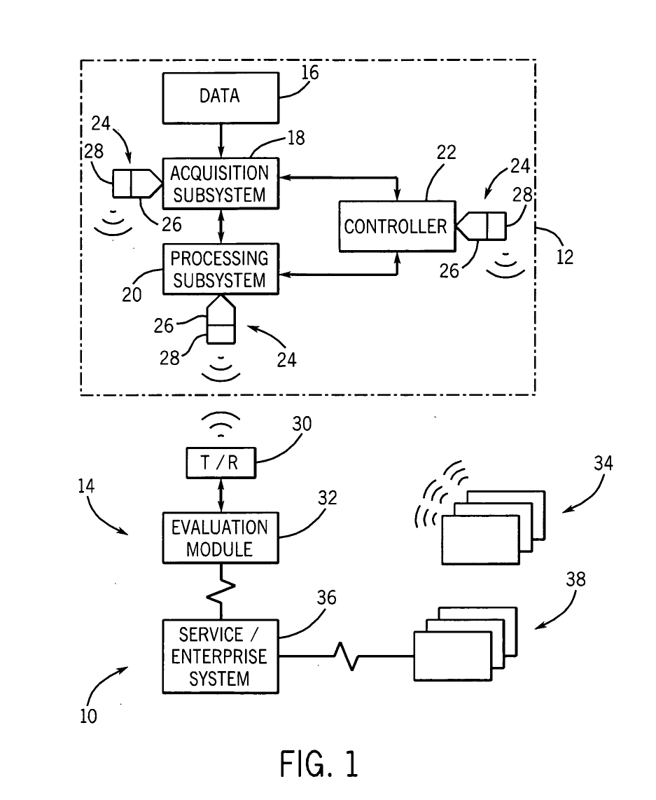

Turning now to the drawings, and referring first to FIG. 1, a healthcare system 10 is generally illustrated that includes sensing and communications technology in accordance with aspects of the present invention. The system 10 may include a wide range of components, systems, sub-systems, and so forth in one or more healthcare institutions. By way of example, a healthcare subsystem 12 is illustrated diagrammatically as coupled to a management subsystem 14. It should be understood that, in the present context, the term “healthcare subsystem” can imply any suitable subsystem of a medical care facility or system, but will typically include machines, imaging systems, monitors, and so forth that collect or operate on patient information, in addition to various components and systems that are included in these. The present concept of a healthcare subsystem, as described more fully below, may also include and extend to suppliers, physicians, pharmaceutical companies and so forth. This is particularly the case in the context of the quality and performance control of expendable, replaceable or consumable components as described below. The term “management subsystem” may include business and/or technical oversight systems. More typically, the management subsystem will include any automated or semi-automated analysis systems for interpreting collected data and evaluating the operational state or performance of the healthcare subsystem or components of that subsystem.

The healthcare subsystem 12, as illustrated in FIG. 1, operates on data 16 which, in general, may include environmental data, parametric data, manufacturing data, patient data, location data, and so forth. Where a patient data is included, any exchange of the patient data in a manner that would identify individual patients is precluded by removal of any such information from the data prior to access outside of the healthcare context or institution in accordance with industry standards. The data will typically be collected, or derived from collected data (e.g., by triangulation in the case of locations), as noted below, during normal operation, transport or other performance of medical care or healthcare task. In general, the data may be stored on any suitable memory device, but will typically be detected, extracted, processed and stored in an acquisition subsystem 18.

The acquisition subsystem 18, which may at least partially be internal to the sensing devices described below, serves to extract raw or partially processed data from components and subsystems within the healthcare subsystem 12 itself. The acquisition subsystem 18 may, for example, be part of an imaging system or other key component in providing healthcare. More generally, however, the acquisition subsystem 18 should be understood as any automated or semi-automated system, typically computerized, for detecting various parameters relating to the provision of healthcare. For example, the acquisition subsystem 18 may collect usage information for particular components, location information, temperature information, pressures, vibration information, and so forth, to mention only a few.

The acquisition subsystem 18 is associated, in a typical embodiment, with a processing subsystem 20. The processing subsystem serves to act on the data 16 acquired by the subsystem 18, such as to filter the information, compute values and parameters of interest based upon the acquired data, and so forth. For example, the processing subsystem 20 may accumulate usage information, convert usage information to tabulated or other forms, compute values such as signal-to-noise ratios, perform asset dynamic allocation/reallocation, as well as carry out any suitable computations that may be informative in evaluating the performance of the healthcare subsystem based upon the data. In general, the acquisition subsystem 18 and the processing subsystem 20 act under the control of a controller 22. The controller 22, in a typical application, may include control routines for regulating the acquisition of the data 16, as well as operations carried out on the data by either the acquisition subsystem or the processing subsystem. Examples of acquisition subsystems, processing subsystems and controllers will be provided in greater detail below.

One or more of the subsystems in the healthcare subsystems will be equipped with an RF sensor module 24. The sensor module, as noted above, may be retrofit to existing devices, systems and components. That is, in presently contemplated embodiments, the RF sensor modules 24 may be add-on devices which can be interfaced with existing components and devices to sense parameters that are either not already sensed on such devices, or that are not available by other means for transmission to external devices for analysis. In other instances, the RF sensor modules may be integrated with existing or new subsystems, such as to transmit information from those subsystems that are already monitored for other reasons than the analysis proposed by the invention.

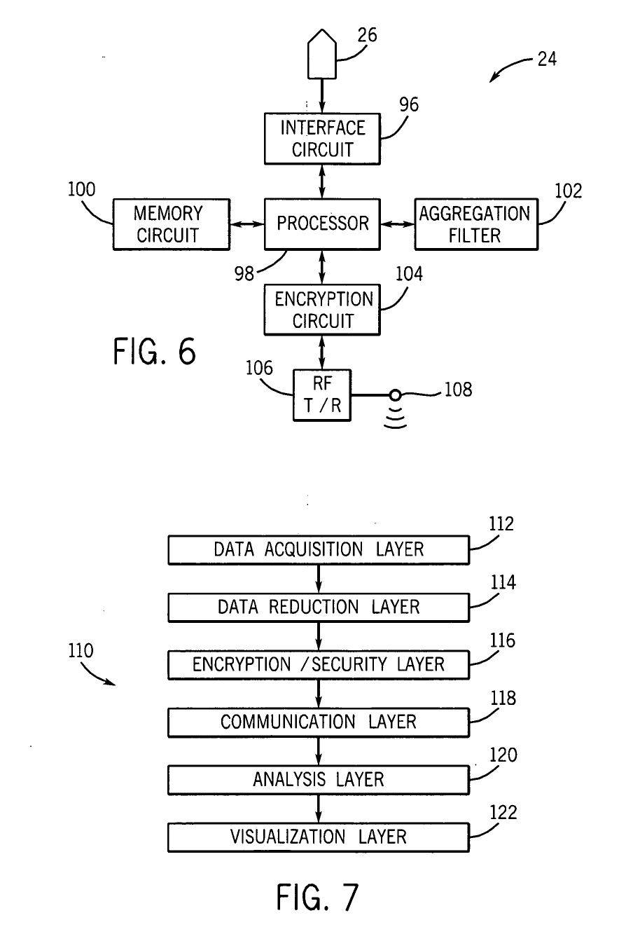

In the illustrated embodiment and as described more fully below, each RF sensor module 24 includes a sensor module 26 and a data handling module 28. In general, the sensor module 26 may be any suitable sensor capable of detecting parameters of interest, and generating signals related to the parameters that can be converted to values for processing and transmission by the data handling module 28. By way of example only, the sensor modules 26 may be adapted for sensing temperatures, pressures, voltages, currents, vibration, radiation, as well as a host of other parameters. The data handling module 28, described more fully below with respect to FIG. 6, serves to store the sensed information, and may process the sensed information, such as to aggregate, compile or condense the information for transmission. The data handling module 28 will be capable of transmitting the sensed information or processed information based upon the sensed information to a transceiver device 30 by means of radio frequency communication, in a manner generally known in the art. The transceiver device 30, one or many of which may be present in the system, serves to prompt transmission of data from the RF sensor modules, and receives the data for further processing and evaluation. The transceiver device 30 may be located in a fixed location, such as on a machine, system or subsystem, or may an ambulatory or mobile device which can be moved from location to location, such as a device that is carried by a maintenance or operations person, or a device attached to stationary or moving patients (e.g., IV pumps).

An evaluation module 32 is coupled to the transceiver device 30 for receiving the data transmitted to the transceiver device from the RF sensor modules. In general, the evaluation module may be part of an overall computer system that is located either local to the healthcare subsystem 12 or remote from the subsystem. For example, evaluation of the data may be performed at the subsystem, or more complex or more integrated evaluation may be provided by a service provider operating remotely but based upon information collected via the transceiver device 30. The evaluation module, as described more fully below, may perform any suitable type of analysis on the information sensed and processed by the RF sensor modules. For example, the evaluation module may perform trending, evaluation of limits (e.g., in usage or for maintenance purposes), evaluation of indicators of defects, failures or potential faults in the healthcare subsystem, and so forth. In the illustrated embodiment, moreover, the evaluation module 32 may receive information and process the information from a host of other healthcare subsystems, indicated generally by reference numeral 34 in FIG. 1. These may include, for example, systems that are similar to or even identical to subsystem 12. This may be the case, for example, of imaging systems, monitors, patient care devices, suppliers of expendable or disposable goods, including pharmaceuticals, blood, and so forth.

The evaluation module 32 may be coupled to a service enterprise system 36 that is designed to evaluate the performance and possible improvements in the healthcare subsystems on an enterprise level. In a presently contemplated embodiment, for example, the service/enterprise system 36 could be subscriber-based, such as a contracted outside party that collects information from the healthcare subsystems and evaluates possible operational service needs. The service/enterprise system 36 may also serve to plan for servicing and replacement of parts, and may evaluate whether existing equipment is operating properly, including equipment of healthcare component providers, transport companies, and so forth involved in the provision of healthcare services or healthcare products. Reference numeral 38 in FIG. 1 represents the input into the service/enterprise system 36 of other data sources that may be considered in such evaluations. By way of example only, such sources may include financial sources, such as for financial and resource planning, personnel sources, such as for planning maintenance and other operations, supplier and inventory sources, such as for planning replacement or improvement in existing systems and components, and so forth. The data sources 38 further include important participants that are nevertheless somewhat ancillary to the healthcare system, such as insurance companies, governmental and quasi-governmental financial institutions, and so forth.

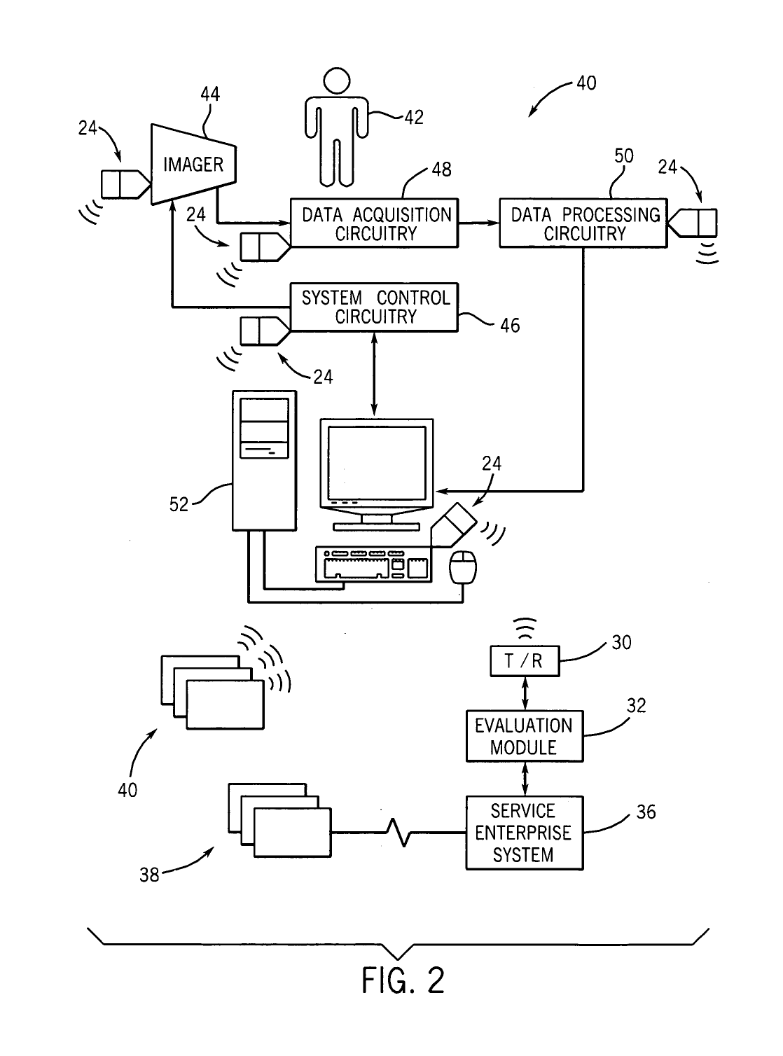

FIG. 2 represents in somewhat greater detail an exemplary healthcare subsystem in the form of an imaging system 40. As illustrated, an imaging system 40 is designed to acquire image data that can be reconstructed to visualize or evaluate tissues, anatomical features and pathologies in a patient 42. The system 40 generally includes some type of imager 44 which detects signals and converts the signals to useful data (typically for image reconstruction). As described more fully below, the imager 44 may operate in accordance with various physical principles for creating the image data. In general, however, image data indicative of regions of interest in a patient are created by the imager either in a conventional support, such as photographic film, or in a digital medium.

The imager operates under the control of system control circuitry 46. The system control circuitry may include a wide range of circuits, such as radiation source control circuits, timing circuits, circuits for coordinating data acquisition in conjunction with patient or table of movements, circuits for controlling the position of radiation or other sources and of detectors, and so forth. The imager 44, following acquisition of the image data or signals, may process the signals, such as for conversion to digital values, and forwards the image data to data acquisition circuitry 48. In the case of analog media, such as photographic film, the data acquisition system may generally include supports for the film, as well as equipment for developing the film and producing hard copies that may be subsequently digitized. For digital systems, the data acquisition circuitry 48 may perform a wide range of initial processing functions, such as adjustment of digital dynamic ranges, smoothing or sharpening of data, as well as compiling of data streams and files, where desired. The data is then transferred to data processing circuitry 50 where additional processing and analysis are performed. For conventional media such as photographic film, the data processing system may apply textual information to films, as well as attach certain notes or patient-identifying information. For the various digital imaging systems available, the data processing circuitry perform substantial analyses of data, ordering of data, sharpening, smoothing, feature recognition, and so forth.

Ultimately, the image data is forwarded to some type of operator interface 52 for viewing and analysis. While operations may be performed on the image data prior to viewing, the operator interface 52 is at some point useful for viewing reconstructed images based upon the image data collected. It should be noted that in the case of photographic film, images are typically posted on light boxes or similar displays to permit radiologists and attending physicians to more easily read and annotate image sequences. The images may also be stored in short or long term storage devices, for the present purposes generally considered to be included within the interface 52, such as picture archiving communication systems. The image data can also be transferred to remote locations, such as via a network. It should also be noted that, from a general standpoint, the operator interface 52 affords control of the imaging system, typically through interface with the system control circuitry 46. Moreover, it should also be noted that more than a single operator interface 52 may be provided. Accordingly, an imaging scanner or station may include an interface which permits regulation of the parameters involved in the image data acquisition procedure, whereas a different operator interface may be provided for manipulating, enhancing, and viewing resulting reconstructed images.

As illustrated in FIG. 2, imaging system 40 thus includes a variety of subsystems. As will be readily apparent to those skilled in the art, the subsystems themselves will include often contain many components, circuits, mounting structures, mechanical parts, and so forth. At least some of these are instrumented with RF sensor modules 24. These may be designed to detect, for example, temperatures, pressures, speeds, vibration, radiation, position, flow rates, current, voltage, and so forth. Each sensor generates signals or values representative of the sensed parameter. These sensed signals are then at least partially processed and stored for later transmission to a transceiver device 30 as described above. Moreover, as mentioned above, while some, or even all of the RF sensor modules may be integrated into the imaging system 40 or its subsystems or components, in a presently contemplated embodiment, the modules may be retrofitted to existing equipment, making the present technique capable of collecting and evaluating data heretofore unavailable. Indeed, the invention also contemplates implementation of RF sensor modules that can only communicate with one another and/or with a transceiver device 30 by way of RF communication (i.e., that are not hard-wired to one another by any means).

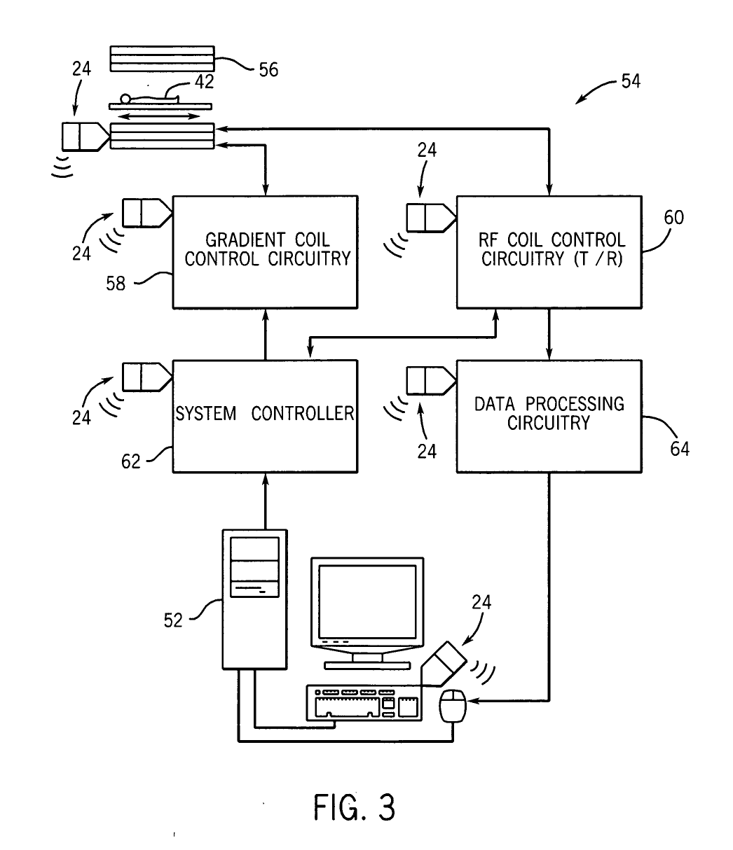

FIG. 3 represents a further specific example of an application for the present RF sensing and data exchange and analysis technique in a specific type of imaging system, a magnetic resonance (MR) imaging system, in this case. The magnetic resonance imaging system 54 includes a scanner 56 in which a patient is positioned for acquisition of image data. The scanner 56 generally includes a primary magnet for generating a magnetic field which influences gyromagnetic materials within the patient's body. As the gyromagnetic material, typically water and metabolites, attempts to align with the magnetic field, gradient coils produce additional magnetic fields which are orthogonally oriented with respect to one another. The gradient fields effectively select a slice of tissue through the patient for imaging, and encode the gyromagnetic materials within the slice in accordance with phase and frequency of their rotation. An RF coil (unrelated to the RF sensor modules) in the scanner generates high frequency pulses to excite the gyromagnetic material and, as the material attempts to realign itself with the magnetic fields, magnetic resonance signals are emitted which are collected by the radio-frequency coil.

The scanner 56 is coupled to gradient coil control circuitry 58 and to RF coil control circuitry 60. The gradient coil control circuitry permits regulation of various pulse sequences which define imaging or examination methodologies used to generate the image data. Pulse sequence descriptions implemented via the gradient coil control circuitry 58 are designed to image specific slices, anatomies, as well as to permit specific imaging of moving tissue, such as blood, and defusing materials. The pulse sequences may allow for imaging of multiple slices sequentially, such as for analysis of various organs or features, as well as for three-dimensional image reconstruction. The RF coil control circuitry 60 permits application of pulses to the RF excitation coil, and serves to receive and partially process the resulting detected MR signals. It should also be noted that a range of RF coil structures may be employed for specific anatomies and purposes. In addition, a single RF coil may be used for transmission of the RF pulses, with a different coil serving to receive the resulting signals.

The gradient and RF coil control circuitry function under the direction of a system controller 62. The system controller implements pulse sequence descriptions which define the image data acquisition process. The system controller will generally permit some amount of adaptation or configuration of the examination sequence by means of an operator interface 52.

Data processing circuitry 64 receives the detected MR signals and processes the signals to obtain data for reconstruction. In general, the data processing circuitry 64 digitizes the received signals, and performs a two-dimensional fast Fourier transform on the signals to decode specific locations in the selected slice from which the MR signals originated. The resulting information provides an indication of the intensity of MR signals originating at various locations or volume elements (voxels) in the slice. Each voxel may then be converted to a pixel intensity in image data for reconstruction. The data processing circuitry 64 may perform a wide range of other functions, such as for image enhancement, dynamic range adjustment, intensity adjustments, smoothing, sharpening, and so forth. The resulting processed image data is typically forwarded to an operator interface for viewing, as well as to short or long-term storage. As in the case of foregoing imaging systems, MR image data may be viewed locally at a scanner location, or may be transmitted to remote locations both within an institution and remote from an institution such as via a network connection.

Here again, the MR imaging system 54 represents an exemplary healthcare subsystem that may be instrumented with RF sensor modules 24 of the type described above. Moreover, as also mentioned above, certain or all of such modules may be retrofitted to the system to collect data on an as-needed basis, such at to evaluate, troubleshoot or otherwise monitor the operational performance of the MR system for any reason. Although not represented again in FIG. 3, the modules 24 will transmit signals to one or more transceiver devices and therethrough to a system for evaluating the operational performance of the MR imaging system or any of its subsystems or components, as well as those of other similar or even different systems. It should be noted that this may be done at various levels, including for the system alone, or on a departmental level (e.g., for a radiology department), at an institutional level (e.g., for “fleet” management or monitoring), or even for a larger population, such as by a service provider who services this and other systems.

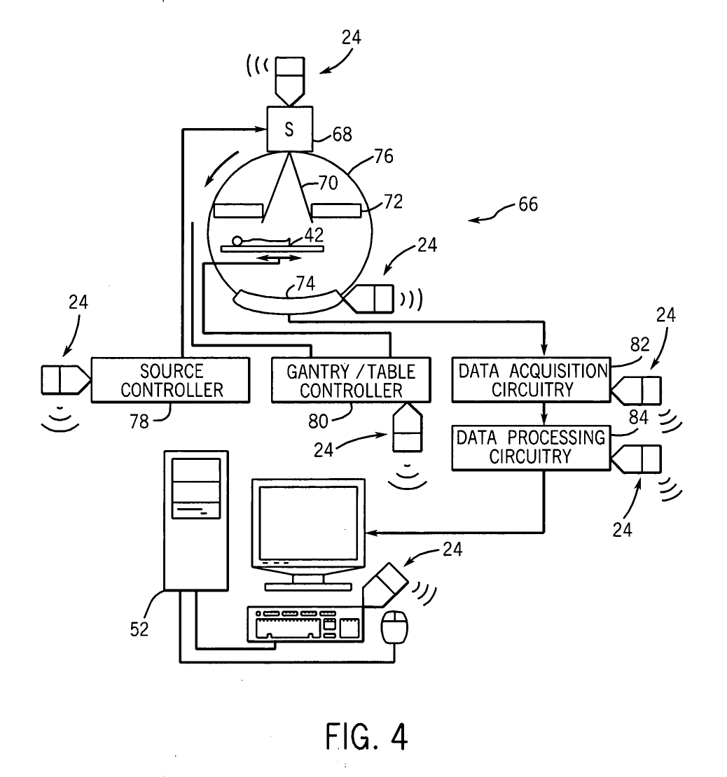

FIG. 4 illustrates a further specific implementation of the invention on another imaging system, in this case a computed tomography (CT) imaging system, as an example of a healthcare subsystem. As shown in FIG. 4, the basic components of a CT imaging system 66 includes a radiation source 68 which is configured to generate X-ray radiation in a fan-shaped beam 70. A collimator 72 defines limits of the radiation beam. The radiation beam 70 is directed toward a curved detector 75 made up of an array of photodiodes and transistors which permit readout of charges of the diodes depleted by impact of the radiation from the source 68. The radiation source, the collimator and the detector are mounted on a rotating gantry 76 which enables them to be rapidly rotated (such as at speeds of two rotations per second). It should be noted, of course, that the illustrated system described here is an example only. Indeed, such CT systems may, in coming designs, include stationary X-ray sources and detectors, or similar components that may or not rotate on a gantry.

During an examination sequence, as the source and detector are rotated, a series of view frames are generated at angularly-displaced locations around a patient 4 positioned within the gantry. A number of view frames (e.g. between 500 and 1000) are collected for each rotation, and a number of rotations may be made, such as in a helical pattern as the patient is slowly moved along the axial direction of the system. For each view frame, data is collected from individual pixel locations of the detector to generate a large volume of discrete data. A source controller 78 regulates operation of the radiation source 68, while a gantry/table controller 80 regulates rotation of the gantry and control of movement of the patient.

Data collected by the detector is digitized and forwarded to a data acquisition circuitry 82. The data acquisition circuitry may perform initial processing of the data, such as for generation of a data file. The data file may incorporate other useful information, such as relating to cardiac cycles, positions within the system at specific times, and so forth. Data processing circuitry 84 then receives the data and performs a wide range of data manipulation and computations.

In general, data from the CT scanner can be reconstructed in a range of manners. For example, view frames for a full 360° of rotation may be used to construct an image of a slice or slab through the patient. However, because some of the information is typically redundant (imaging the same anatomies on opposite sides of a patient), reduced data sets comprising information for view frames acquired over 180° plus the angle of the radiation fan may be constructed. Alternatively, multi-sector reconstructions are utilized in which the same number of view frames may be acquired from portions of multiple rotational cycles around the patient. Reconstruction of the data into useful images then includes computations of projections of radiation on the detector and identification of relative attenuations of the data by specific locations in the patient. The raw, the partially processed, and the fully processed data may be forwarded for post-processing, storage and image reconstruction. The data may be available immediately to an operator, such as at an operator interface 136, and may be transmitted remotely via a network connection.

In this example, too, subsystems and components of the CT system 66 may be instrumented via RF sensor modules 24. As before, some or all of the modules may be retrofitted to the CT system for collecting data on an as needed or permanent basis. The modules, as described above, may process the collected data and transmit raw or processed data to other modules or to a transceiver for evaluation of the data on a component level, a system level or at a higher level.

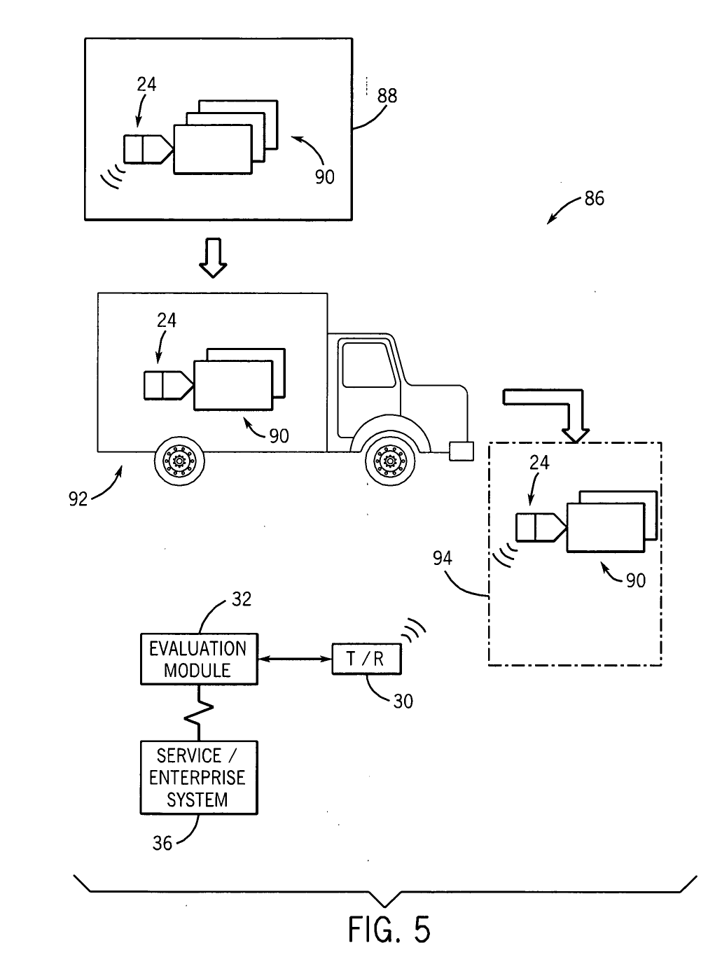

FIG. 5 illustrates a somewhat different implementation of the present technique for sensing, transmitting and analyzing component data via RF sensor modules. In the implementation of FIG. 5, an inventory monitoring system 86 is generally illustrated. The monitoring system may, for example, be carried out on products whose delivery or conditions during delivery and storage are highly sensitive, such as blood, plasma, pharmaceuticals, sensitive parts and field replaceable units, and so forth. In the illustrated embodiment, then, a storage facility 88 is illustrated as including a series of products 90. In an exemplary embodiment discussed here, the products may be considered packets of blood collected and designed to be transported to and used for medical purposes. The products 90 are associated with an RF sensor module 24, such as for sensing the environmental temperature in the immediate vicinity of the products. The modules may also be used to track or monitor the actual conditions of the product itself, as sensed by the sensor portion of the module. The temperatures are logged periodically and stored in the module 24 as described in greater detail below.

When needed or ready for use, the products 90 are transferred to a transportation system, as indicated generally by reference numeral 92. In the case of blood or plasma, the transportation will be carried out in refrigerated or, more generally, environmentally controlled environments, including in trucks, containers, and other vehicles. The temperatures, in this particular use case, are continuously sensed and logged by the RF sensor modules 24. Ultimately, then, the product 90 are delivered to a healthcare institution as indicated generally by reference numeral 94. During the entire cycle of product storage and delivery, then, parameters of interest regarding both the environment, the condition of the products, and so forth can be sensed and logged.

At any stage in the storage, transport and use of the products, then, data can be detected and transmitted from the RF sensor modules 24 by means of a transceiver device 30. Such transceiver devices may be used, for example, in the storage facility 88, in the transportation system 92, and/or in the institution 94. By way of example, continuing with the use case of blood or plasma, temperatures reigning in any one of the phases of storage and delivery can be sensed and logged. An evaluation module 32 may, then, evaluate this data to determine whether conditions were suitable in the various phases of handling. If temperatures exceeded acceptable temperatures for extended durations, for example, the product may be indicated as a suspect. A service/enterprise system 36, then, may indicate this fact and either perform quality control or disqualifications of certain products or components, or may recommend changes at various phases of the product cycle. It should be noted, however, that the inventory monitoring system 86 of FIG. 5 is yet another example only of implementation of the present system. Similar techniques may, of course, be applied for other components stored, transported and used in the healthcare context.

FIG. 6 illustrates exemplary components or functional units that may be included in an RF sensor module 24. As noted above, the modules will include one or more sensors 26 for detecting environmental, parametric, or other characteristics of the healthcare system being monitored. Other circuitry that could be included in the modules includes an interface circuit 96 designed to receive signals from the sensor and to convert them to a useable form. Such interface circuitry may include, for example, analog-to-digital converters, scaling circuits, filtering circuits, bandpass filters, and so forth. A processor 98 may be included for receiving and further manipulating the data or signals based upon output of the interface circuit 96. In exemplary implementations, for example, processor 98 may have limited functionality, but nevertheless be capable of performing certain calculations, logging functions, trending functions, and so forth. Processor 98 may consist of a conventional microprocessor, digital signal processor, or any other suitable processing circuit. A memory circuit 100 stores both instructions for processing carried out by the processor 98, and collected data, which may be stored in raw, partially processed, or processed form. That is, memory circuit 100 may store historical data available from the processor, calculations made based upon the sensed data, and so forth.

In a present implementation, an aggregation filter 102 may be provided. The aggregation filter may, in certain implementations, consist of programming stored in memory circuit 100 and carried out by processor 98. Because many different types of data may be sensed and processed in the modules, including multiple formats of data (text, waveform, multimedia, audio, video, image, currents, voltages, and so forth), the aggregation filter 102 may be used to distill or otherwise accumulate or condense the data into a more manageable form. In particular, the aggregation filter will typically be capable of associating data in a logical format, so as to tie the location of the sensor with device characteristics and an identification of either the sensor or the product to which the sensor is coupled. Indeed, the module itself may include localization circuitry, such as global position system (GPS) capabilities. The modules may also include an encryption circuit 104, which may encrypt data, provide for restricted access to data, convert data to a particular network protocol, and so forth. The encryption circuit, where included, will be capable of sending and receiving data by any suitable protocol, such as conventional network protocols used in mobile telephony, computing, and similar applications. The RF transceiver itself 106 is coupled either to the processor or to the processor through the encryption circuit 104. The transceiver may operate on any one of several standard RF frequencies, such as 915 MHz or 13.56 MHz. The RF transceiver 106 itself will be coupled to an RF antenna 108 for transmitting and receiving data.

As noted above, some or most of the processing carried out on data collected by the RF sensor modules may be performed within the modules themselves, or at locations remote from the modules. Where appropriate, certain of the modules may detect data from other modules, aggregate the data and report the data to outside circuitry. Indeed, much of the processing for evaluation, troubleshooting, failure detection, maintenance scheduling, system improvement, and so forth may take place at completely remote locations, such as service provider locations. More specifically, the sensor information, in conjunction with the identification information for the system or subsystem and the location information, may enable the collection and analysis of information relating to the need for or availability of mobile equipment, the need for servicing of equipment, the need for maintenance of equipment, and so forth, as well as for actually scheduling such operations. Location information, in particular, may save considerable time in locating both movable equipment, systems and sub-systems, and stationary equipment (e.g., one of a number of similar systems or pieces of equipment) or subsystems within such equipment.

FIG. 7 illustrates various data acquisition and processing layers in the overall system of the present technique in accordance with a presently contemplated embodiment. That is, the various layers illustrated in FIG. 7 will not typically be performed in a single device, such as a sensor module, but will be performed by cooperation of several devices, subsystems and even remote providers discussed above.

In the processing system 110 illustrated diagrammatically in FIG. 7, a data acquisition layer 112 consists of components which sense parameters of interest relating to the components and subsystems monitored, and generate signals representative of them. A data reduction layer 114 may include certain of the aggregation operations performed within one or more of the sensor modules discussed above.

In general, the data reduction process can be achieved by either horizontal or vertical reduction, generalization of lower level concepts to a higher level, and summarization of the data for transforming of the data to higher level concepts. By way of example only, such data reduction may include averaging, summing, counters, trending, transformation (e.g., via fast Fourier transforms or other transforms), curve fitting, and so forth. Layer 114 is believed to be particularly important for implementation of the present technique insomuch as the sensors may, in practical applications, generate large volumes of raw data on a host of components. Such data would be quite expensive to store, retrieve, transmit and process. Hence, data reduction layer 114 allows for a reduction in the volume of the data while limiting the loss of information entropy. This layer also provides for abstraction of various data in various formats by converting the data into a common format. Such consistent formats prepare the data for easy and efficient analysis in downstream layers.

An encryption/security layer 116 provides for encrypting the data, where desired, and limiting access to the data, such as via conventional passwords or the like. That is, the ability to upload or download data from or to the sensor modules is preferably limited, precluding unauthorized access to the information, changing of the information, and so forth. The communication layer 118, then, provides for extracting information from sensors, setting parameters on the sensors, setting such hardware options as baud rates, sensing intervals, and other programming that may be carried out by the sensor modules. Once implemented, the communication layer 118 will essentially serve the role of extracting information sensed by, processed on and stored on the sensor modules.

Analysis layer 120 summarized in FIG. 7 may at least partially take place on the sensor modules, but in most embodiments will take place externally. The analysis layer effectively forms the bulk of the data manipulation and use in the invention. That is, a set of analysis modules may be provided that will typically be adapted carefully to the data collected, and the purpose for which the data is collected. The analysis modules may begin with the raw or processed data from the sensor modules and perform further processing for particular analysis purposes. Analysis may, for example, consist of asset, patient, personnel management, and other similar purposes. This type of analysis may, effectively, follow generally existing or future schemes for asset management, patient and asset tracking, and the like. The analysis may also relate the location of the device known from the location of the sensor module. In applications where the monitored devices or components are in a fixed location, this location may be stored in the sensor module when placed in service. For mobile components, as described above, in the case of the storage and delivery embodiments, the location may be communicated to the sensors from transmitters in storage and transport phases of component handling, or may be sensed by the devices, such as through GPS navigation systems. The analysis may also act on characterizing data, such as to determine the operational state of the component or system or subsystem on which the sensor modules are placed, this will particularly be true of sensors placed on machinery, such as imaging systems, where sensed information may provide indications of such factors as heating, overheating, cycle times, radiation levels, and so forth.

The various processing layers summarized in FIG. 7 will typically terminate in some sort of visualization layers 122. Indeed, one of the primary purposes of collecting and analyzing the data is to inform maintenance or supervisory personnel of the state and operability of the components, systems and subsystems that are monitored. A myriad of visualization techniques may be applied in layer 122, including graphical user interfaces, trend presentations, reports such as for utilization for evaluation of data-driven maintenance needs, alerts and alarms, and so forth. Essentially, layer 122 is an interface layer that provides useful summaries of analyzed data collected from the RF sensor modules for any suitable use, closing the loop on the purpose for which the monitoring is performed.

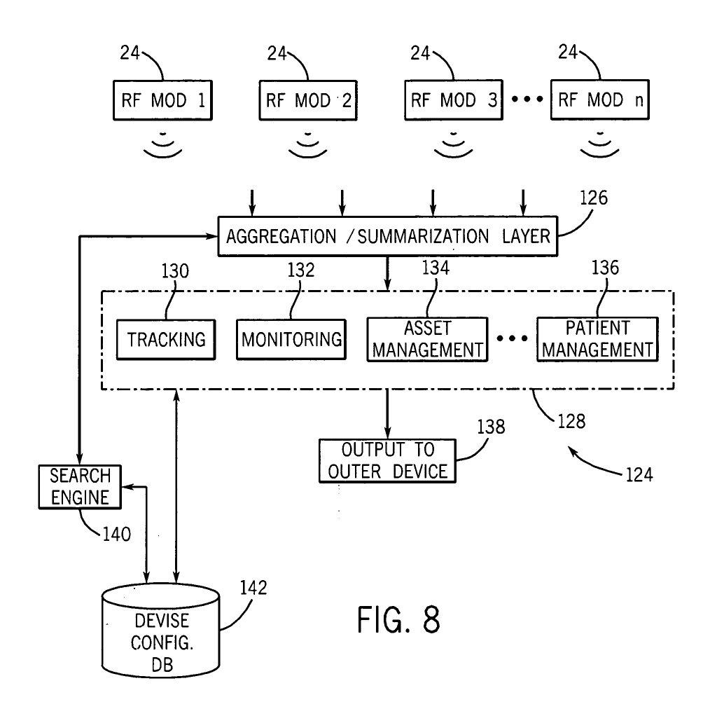

FIG. 8 illustrates the overall scheme of a system, based upon the layered structure of FIG. 7, in a practical implementation. As noted above, any number of RF sensor modules 24 may be provided in a typical system 124. The aggregation/summation layer, labeled 126 in FIG. 8, essentially performs those functions summarized above with respect to layer 114 of FIG. 7. Layer 126 may perform analysis of the inputs from the RF sensor modules tailored to a specific type of analysis implemented by an analysis engine 128. Such filtering will be helpful in mapping data into a proper perspective for the type of analysis to be performed. Again, the aggregation/summarization layer 126 may exist on the RF sensor modules themselves, or in a “back office” or centralized or distributed location, such as at a service provider, enterprise-level management or analysis facility, and so forth. The output of layer 126 may effectively be a link to a file, a file, such as in an XML or ASCII format, or other desired file formats.

Analysis engine 128 will perform various analysis functions, certain of which are generally summarized in FIG. 8. In general, the analysis engine will be capable of locating, characterizing, detecting, diagnosing, monitoring, alerting or informing personnel, billing, contracting, tracking of inventories, predicting usage and maintenance needs, fleet analysis, and so-forth. Certain of these functions are discussed in greater detail below. In the embodiment illustrated in FIG. 8, for example, one or more modules may be provided in the analysis engine 128, each module generally consisting of software or software suites that act upon the collected and aggregated data. For example, asset tracking may be performed as indicated at reference numeral 130 for locating, counting, and analyzing the distribution of assets, and the needs for assets in the same or other locations within the healthcare system. Monitoring functions may be carried out as indicated as reference numeral 132, such as simply for collecting information from the modules and monitoring performance of the overall healthcare system or a particular component or subsystem. Asset management functions, as indicated at reference numeral 134 may include analysis of the operational performance of particular devices, their need for repair or replacement, financial analysis of their usage over time, and so-forth. Finally, patient management functions, as indicated generally by reference numeral 136 may be performed. Such patient management may include determination of patient needs, scheduling of patient care, and so-forth. As noted above, where particular patients are involved in such analysis, the system will typically be configured to limit access to such information in conformance with applicable standards and laws.

As noted above, the results of such analysis will typically be output to other devices as indicated generally by reference numeral 138 in FIG. 8. Such output may include transfer of data to enterprise-level analysis programs are capable of associating the analyzed data with similar data for other components or assets. The other devices may also be capable of ordering replacement parts, scheduling part servicing or replacement, scheduling personnel for a system or patient care, or any other suitable operation performed on the analyzed data. Moreover, a search engine 140 may be provided that can interact with the aggregation/summarization layer 126, or indeed with the other layers of the system. In general, the search engine is a component used to perform targeted selection of data. The search engine may help obtain the most relevant data for a particular purpose quickly, while providing correct and relevant information to a problem or issue at hand. The search engine 140 may interface with automated systems or a user work station (not shown) to perform searches on the collected information. Indeed, the search engine 140 may prompt a special collection of information, such as by polling, from individual RF sensor modules or collections of modules, such as on a particular subsystem or system. The search engine 140 assists in performing such searches, and may interface with a device configuration database 142, such as for comparing sensor processed data with data for a fleet of similar devices, or with a base or “golden rule” configurations. In general, the device configuration database may store any or all of the configuration information for the RF sensor modules 24, or the components and subsystems with which the modules are associated.

As will be appreciated by those skilled in the art, a goal of the foregoing scheme is to acquire any type of data in any format and utilize such data to the fullest extent possible to provide servicing of the components and subsystems, as well as to the overall healthcare system, particularly where the monitored component or subsystem is shared or transported between segments of the healthcare system. As a further example, it is assumed that vibration data is collected from a component, to be used in generalizing and summarizing the potential for mechanical failure of the associated device. In general, the data is fed into the detection analysis engine 128. This engine detects, for example, a trend in vibration data and the failure or servicing of the mechanical device may be predicted or scheduled based upon deterioration in a vibration index or comparison. This information is then output to the visualization layer, such as to inform or alert operations personnel of the need for attention and servicing.

Such operations may either be performed locally at the device (i.e. local to the RF sensor module), such as by a service engineer present on site, or they may be performed remotely. Such operations can, moreover, be “stand alone” in terms of the particular component or subsystem, or may be integrated with other applications and analysis of other equipment. There may also be performed at a central location on all data collected for a set of components or systems.

The various types of data collected in accordance with the presently contemplated embodiments may be used for various purposes in both the RF sensor modules and the later signal processing and analysis. For example, location information will generally provide for the physical location of the monitored component or subsystem to facilitate physical access to that component or subsystem by operations personnel. The location information may also be correlated to problems occurring in the overall healthcare system, such as failures of cooling equipment, transportation equipment, and so-forth. Characterizing information may provide various parameters to uniquely characterize a component or subsystem. For example, these may include installation dates and times, installation data, device configuration, information, part numbers, and so-forth. As noted above, detected data will typically include sensor data and/or device characteristic data. Such data may be used to predict a fault state of the component or subsystem or a trend towards a serviceable condition or even failure. Operations performed on such data may be used to alert or inform operations personnel, diagnose operational problems, schedule servicing, and so-forth, either in automated, semi-automated or manual procedures.

As noted above, monitoring operations performed on the basis of location information, operational information, and stored medical equipment information may be used to provide a synopsis of the operational state or health of the component or subsystem being monitored. Such monitoring may provide logs of the monitored parameters or of values computed based upon the monitored parameters. Alerts and notices, then, may be formulated for operations personnel.

Management functions may also be performed based on the data, as mentioned above. For example, billing operations may be based on the information, such as in environments where counts of products are involved, where services are performed, where parts or replaceable components are ordered, and so-forth. Such billing operations may typically be based upon usage information captured via the RF sensor modules described above. Similarly, contract operations may extract relevant information from the sensed data, and apply such information in data mining operations. Such contract operations may, for example, monitor conformance with service contracts, predict needs for additional or enhanced service contracts, and so-forth. Similarly, inventory operations, as mentioned above, may be performed to ensure that sufficient inventories are available or ordered, to track defects or needs for improved inventory or environmental management, and so-forth. By way of example, in the example of the supply and transport of blood or plasma discussed above, particular problems associated with temperature control in inventory storage and transportation could be identified.

More generally, a fleet control operations may be performed, such as by comparing a particular component or subsystem with other, generally similar components or subsystems. Such fleet control may determine whether a component or subsystem is an outlier as far as failure, usage, heating, efficiency, or any other parameter or conclusion is concerned. For manufacturers and suppliers, this may also quantify distinctions between normal products and products exhibiting aberrational behavior, for product improvement or comparison of manufacturing lines, suppliers, and so-forth. Finally, repair, fix, correct, and self-healing operations may be performed for analyzing the root cause of existing or potential failures as detected by the RF sensor modules. Such operations may invoke a diagnostic routine that can automatically locate the potential cause of aberrational behaviors to individual components or subsystems, based upon information collected from the various RF sensor modules.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A medical equipment system comprising:
a medical data subsystem configured to access medical data;
a data processing subsystem configured to at least partially process the medical data for use in providing medical care;
a controller subsystem for regulating operation of the medical data subsystem and the data processing subsystem;
a plurality of sensors associated with at least one of the medical data subsystem, the data processing subsystem and the controller subsystem for collecting serviceable medical equipment parameter data relating to an operational state of the associated subsystem, each sensor being operatively associated with a radio frequency (RF) transmitter; and
an RF reader for retrieving sensor data and location data from the associated subsystem by RF transmission from the respective transmitter.

2. The system of claim 1, wherein the equipment system is an imaging system, the medical data includes image data, and the data processing subsystem processes the image data to derive therefrom data for reconstructing a medical image.

3. The system of claim 2, wherein the subsystems and the RF reader are internal to the imaging system.

4. The system of claim 3, further comprising an evaluation module for determining operational servicing needs for the medical equipment system based upon the serviceable medical equipment parameter data.

5. The system of claim 4, wherein the RF transmission is the sole data transmission link between the sensors and the evaluation module.

6. The system of claim 4, wherein the evaluation module is remote from the medical imaging system.

7. The system of claim 1, further comprising a filter coupled to at least one of the sensors for aggregating at least part of the serviceable medical equipment parameter data, wherein the aggregated sensor data is subject to collection via the transmitter and the reader.

8. The system of claim 1, further comprising a security module operationally associated with the transmitter, the security module regulating access to the serviceable medical equipment parameter data.

9. The system of claim 8, wherein the security module encrypts the serviceable medical equipment parameter data.

10. A system for servicing medical equipment comprising:
a subsystem including an integrated radio frequency (RF) sensor device including: a memory to store medical equipment information, a sensor portion including a sensor to measure serviceable medical equipment parameter data and in communication with the memory, a filter for aggregating at least part of the sensor data, and a transmitter for outputting at least part of the aggregated data and stored medical equipment information; and
an RF reader for retrieving the aggregated data and medical equipment information from the transmitter and extracting medical equipment information from the aggregated data for transmission to a service system that evaluates the serviceable medical equipment parameter data.

11. The system of claim 10, wherein the equipment information includes location and identification data for the subsystem.

12. The system of claim 10, wherein the medical equipment includes an imaging system including a plurality of subsystems having respective integrated RF sensor devices, at least one of the subsystems being configured to acquire medical image data.

13. The system of claim 12, wherein the subsystems and the RF reader are internal to the imaging system.

14. The system of claim 10, further comprising an evaluation module for determining operational servicing needs for the medical equipment system based upon the aggregated data.

15. The system of claim 14, wherein RF transmission is the sole data transmission link between the integrated RF sensor devices and the evaluation module.

16. A medical equipment service system comprising:
a medical equipment system including a plurality of radio frequency (RF) linked subsystems, each of the subsystems including a sensor for collecting serviceable medical equipment parameter data from the subsystem and an RF transmitter for transmitting the operational data from the subsystem;
an RF reader for retrieving the serviceable medical equipment parameter data from the subsystems; and
a service system for evaluating the serviceable medical equipment parameter data retrieved via the RF reader and for determining operational servicing needs for the medical system based upon the serviceable medical equipment parameter data.

17. The system of claim 16, further comprising a data aggregation filter for deriving service data from the serviceable medical equipment parameter data.

18. The system of claim 16, wherein the RF transmission is the sole data transmission link for collecting the serviceable medical equipment parameter data from the sensors.

19. The system of claim 16, wherein the service system is remote from the medical equipment system.

20. The system of claim 16, further comprising a security module operationally associated with the transmitter, the security module regulating access to the serviceable medical equipment parameter data.

21. A system for servicing medical equipment comprising:
a contributing entity contributing to the provision of medical care via an article, the article including an integrated radio frequency (RF) sensor device including: a memory to store medical article information, a sensor portion including a sensor to measure serviceable medical article parameter data and in communication with the memory, a filter for aggregating at least part of the sensor data, and a transmitter for outputting at least part of the aggregated data and stored medical article information;
an RF reader for retrieving the aggregated data and medical article information from the transmitter; and
an analysis system that identifies defects or service needs to the contributing entity based upon the aggregated data and the medical article information.

22. The system of claim 21, wherein the article is portable, and the sensor collects the serviceable medical article parameter data during movement of the article.

23. The system of claim 21, wherein the contributing entity is a supplier of articles to a medical institution that renders medical care utilizing the articles.

24. A method for servicing medical systems comprising:
storing data in a sensing module associated with a medical asset, the data including data representative of: the identification of the medical asset, at least one sensed parameter of the medical asset, and the location of the medical asset; and
via a radio frequency (RF) reader, collecting the data from the sensing module.

25. The method of claim 24, wherein the medical asset is stationary.

26. The method of claim 24, wherein the medical asset is mobile.

27. The method of claim 24, further comprising locating the medical asset based upon the collected data.

28. The method of claim 24, further comprising evaluating a need for service of the medical asset based upon the collected data.

29. The method of claim 24, further comprising similarly collecting data from other similar medical assets and aggregating the data to determine an asset management strategy for the assets.

30. The method of claim 29, wherein the management strategy includes determining a need or availability of similar assets.
